(19) United States
(12) Patent Application Publication
(10) Pub. No.: US 2025/0294253 A1
(43) Pub. Date: Sep. 18, 2025

(54) CAMERA STRUCTURE

(71) Applicant: Luxshare Intelligent Manufacture Technology (Changshu) Co., Ltd, Changshu City (CN)

(72) Inventors: Po-Ying TSENG, Changshu City (CN); Li-Jhen CHEN, Changshu City (CN)

(73) Assignee: Luxshare Intelligent Manufacture Technology (Changshu) Co., Ltd, Changshu City (CN)

(21) Appl. No.: 19/078,660

(22) Filed: Mar. 13, 2025

(30) Foreign Application Priority Data
Mar. 14, 2024 (CN) 202410295123.6

(51) Int. Cl. H04N 23/68; H04N 23/54

(52) U.S. Cl. CPC H04N 23/68; H04N 23/54

(57) ABSTRACT

A camera structure includes a frame unit and a moving unit. The frame unit includes a framework and a first driver. A corner of the inner surface of the framework includes a linear chute. The moving unit includes a moving base, a magnetic set, and a plurality of balls. The moving base is installed in the framework, the magnetic set is installed on the moving base, and the magnetic set is corresponded to the first driver. A corner of the outer surface of the moving base includes a linear groove. The surface of the plurality of balls abuts the linear groove and the curved groove bottom of the linear chute. The first driver drives the magnetic set to bring the moving base to move. The moving base slides against the plurality of balls within the curved groove bottom of the linear chute.

### CROSS REFERENCE TO RELATED PRESENT DISCLOSURE

This application claims the priority benefit of Chinese Patent Application Serial Number 202410295123.6, filed on Mar. 14, 2024, the full disclosure of which is incorporated herein by reference.

### BACKGROUND OF THE INVENTION

### 1. Field of the Invention

The present disclosure relates to the technical field of photography, more particularly, it relates to a targeted camera structure.

### 2. Description of the Related Art

The camera devices usually have an anti-shake mechanism; when a user holds the device for video shooting, the user's hand may shake or vibrate, affecting the quality of the captured images, and the optical anti-shake technology can compensate for the light of the image to achieve high-quality captured images. However, the prior art employs a ball-type anti-shake design, where the ball rolls within a groove, but the rolling direction of the ball is restricted by the direction of the groove's notch. To design an anti-shake moving structure that allows multi-directional movement, multiple balls and grooves in various directions are required, while also avoiding movement direction restrictions caused by the structure, that greatly limits the internal design of the camera device in terms of space and structural direction.

### SUMMARY OF THE INVENTION

A camera structure which is provided includes: a frame unit and a moving unit. The frame unit includes a framework and a first driver, the first driver is located on the framework, an inner surface of the framework includes a linear chute, a groove bottom of the linear chute is a curved groove bottom; and a moving unit includes a moving base, a second driver and a plurality of balls, the moving base is installed in the framework, the second driver is located on the moving base, the second driver is corresponded to the first driver, an outer surface of the moving base includes a linear groove, the linear groove is corresponded to the linear chute, a notch of the linear groove is smaller than a notch of the linear chute, a surface of the plurality of balls abuts an inside of the linear groove and the curved groove bottom of the linear chute; wherein the first driver drives the second driver to bring the moving base to move, the moving base abuts the plurality of balls to slide on the curved groove bottom of the linear chute, a rotation arc of the moving base is the same as an arc of the curved groove bottom.

In one of the embodiments, the first driver further includes a lifting coil, the lifting coil is located on one side of the framework, the second driver further includes a lifting second driver, the lifting second driver is located on the moving base, the lifting second driver is corresponded to an inside of the lifting coil, and the lifting coil drives the lifting second driver to bring the moving base to move up and down.

In one of the embodiments, the first driver further includes two rotating coils, the two rotating coils are respectively located on two opposite sides of the framework, the second driver further includes two rotating magnetic sets, the two rotating magnetic sets are respectively located on two opposite sides of the moving base, the two rotating magnetic sets are corresponded to the two rotating coils, and the two rotating coils drives the two second drivers to bring the moving base to rotate.

In one of the embodiments, each of the rotating magnetic sets includes a first magnetic pole and a second magnetic pole, the first magnetic pole and the second magnetic pole are arranged side by side, and two magnetic poles corresponded to the two rotating magnetic sets are different from each other.

In one of the embodiments, an amount of the linear chute is two, the two linear chutes are respectively located at two corners of the inner surface of the framework, the moving base rotates relative to the framework, a distance from a rotation center of the moving base to the curved groove bottom of the two linear chutes are the same.

In one of the embodiments, the linear groove of the moving base is a V-shaped groove, the plurality of balls are located in the linear groove, the surface of the plurality of balls respectively abuts two groove walls on two sides of the linear groove.

In one of the embodiments, each of the plurality of balls is in two-point contact with the linear groove, and each of the plurality of balls is in single-point contact with the curved groove bottom.

In one of the embodiments, the linear groove includes a groove bottom and two groove walls, the groove bottom is located between the two groove walls, the two groove walls extends obliquely from two sides of the groove bottom towards the framework and away from each other, the surface of the plurality of balls respectively abuts the two groove walls of the linear groove, and a gap is between the plurality of balls and the groove bottom.

In one of the embodiments, the linear chute further includes two ball limiting walls, the two ball limiting walls are located on two sides of the curved groove bottom, and the two ball limiting walls extend obliquely from two sides of the curved groove bottom towards the moving base and away from each other.

In one of the embodiments, the frame unit further includes two translational magnetic units, the two translational magnetic units are located on an inside of the framework and away from an corner of the linear chute, the moving unit further includes a bearing base and two translation coils, the bearing base is located on the moving base, the two translation coils are located at two corners of the bearing base, the two translation coils are corresponded to the two translational magnetic units, the two translation coils and the two translational magnetic units interact with each other, and the two translation coils bring the bearing base to move horizontally.

In one of the embodiments, the camera structure further includes an elastic part, the elastic part is surrounded between the framework and the bearing base, the elastic part includes two first fixing parts and the two second fixing parts, the two first fixing parts are located on two opposite sides of the elastic part, the two second fixing parts are located on the other two opposite sides of the elastic part, the two first fixing parts are located on the framework, and the two second fixing part are connected to the bearing base.

In one of the embodiments, an inner corner of the framework away from the linear chute includes a bearing platform, the two translational magnetic units are placed on the bearing platform, a part of the moving base protrudes below the bearing platform, and the bearing platform is located on a moving path of the moving base.

In one of the embodiments, the camera structure includes an electrical unit, the electrical unit is located under the frame unit and the moving unit, the electrical unit is electrically connected to the first driver, the electrical unit further includes a sensor and a flexible circuit board, the sensor is corresponded to the moving base, one end of the flexible circuit board is connected to the sensor, the other end of the flexible circuit board extends to an outside of the framework, after the other end of the flexible circuit board extends vertically and upwardly, the other end of the flexible circuit board is divided into two sides and extends along a side of the framework.

In one of the embodiments, the moving base includes a first notch on a surface opposite to the electrical unit, the framework includes a second notch on a surface opposite to the electrical unit, the first notch of the moving base are corresponded to the second notch of the framework, the other end of the flexible circuit board passes through the first notch of the moving base and the second notch of the framework in sequence.

### BRIEF DESCRIPTION OF THE DRAWINGS

The accompanying drawings provided herein offer a further understanding of the present disclosure, constituting a part of the present disclosure, the illustrative embodiments and descriptions of the present disclosure are intended to explain the present disclosure and do not constitute undue limitations on the present disclosure. In the drawings:

FIG. 1 is a perspective view of the camera structure in an embodiment of the present disclosure;

FIG. 2 is an exploded view of the camera structure in an embodiment of the present disclosure;

FIG. 3 is an exploded view of the internal structure of the camera structure in an embodiment of the present disclosure;

FIG. 4 is another exploded view of the internal structure of the camera structure in an embodiment of the present disclosure;

FIG. 5 is a top view of the internal structure of the camera structure in an embodiment of the present disclosure;

FIG. 6 is an enlarged view of area A in FIG. 5;

FIG. 7 is yet another exploded view of the internal structure of the camera structure in an embodiment of the present disclosure;

FIG. 8 is yet another exploded view of the internal structure of the camera structure in an embodiment of the present disclosure; and

FIG. 9 is a schematic view of the driving direction of the camera structure in an embodiment of the present disclosure.

Description in conjunction with the drawings is as follows: 1: camera structure; 11: frame unit; 111: framework; 1110: second notch; 1111: bearing platform; 112: first driver; 113: linear chute; 1131: curved groove bottom; 1132: ball limiting wall; 114: lifting coil; 115: rotating coil; 116: translational magnetic unit; 12: moving unit; 121: moving base; 1210: first notch; 122: second driver; 123: ball; 124: linear groove; 1241: groove bottom; 1242: groove wall; 125: lifting magnetic set; 125A: first magnetic pole; 125B: second magnetic pole; 126: rotating magnetic set; 126A: first magnetic pole; 126B: second magnetic pole; 127: bearing base; 128: translation coil; 13: elastic part; 131: first fixing part; 132: second fixing part; 14: lens unit; 15: electrical unit; 151: sensor; 152: flexible circuit board; 16: outer case; 161: lower case; 162: upper case; 1620: lens hole.

### DETAILED DESCRIPTION OF THE PREFERRED EMBODIMENT

The following will disclose multiple embodiments of the present disclosure with reference to the drawings. For clarity, many implementation details will be explained in the following descriptions. However, it should be understood that these implementation details should not be used to limit the present disclosure. In other words, these implementation details are not essential in some embodiments of the present disclosure. Furthermore, to simplify the drawings, some conventional structures and components will be depicted in a simplified schematic manner. In the following embodiments, the same reference numerals will be used to denote the same or similar components.

A camera structure is provided in some embodiments of the present disclosure, which can offer multi-directional displacement for the balls through the design of a linear chute on the inside of the framework, to solve the problem of movement direction restrictions caused by the internal structural design space limitations of the camera structure.

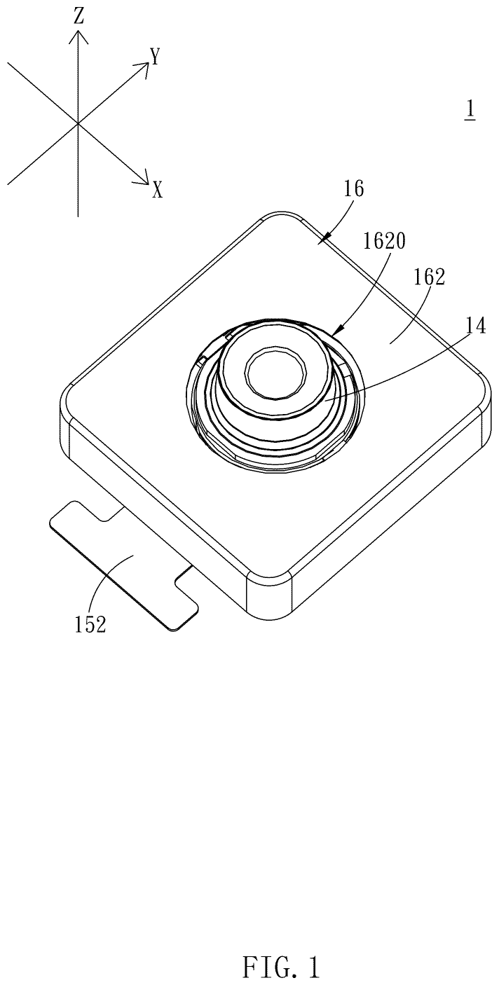

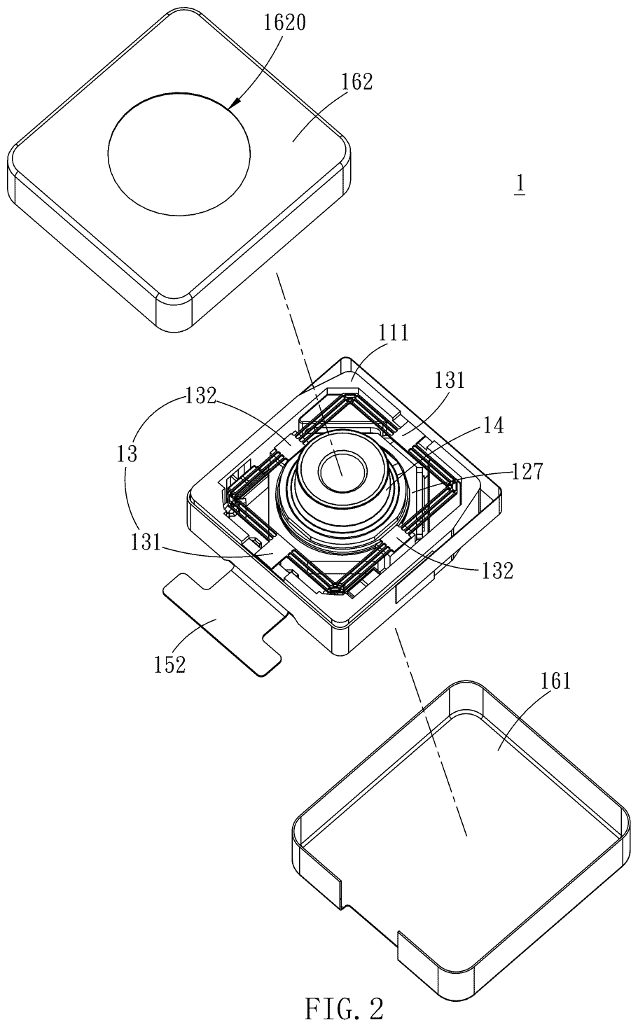

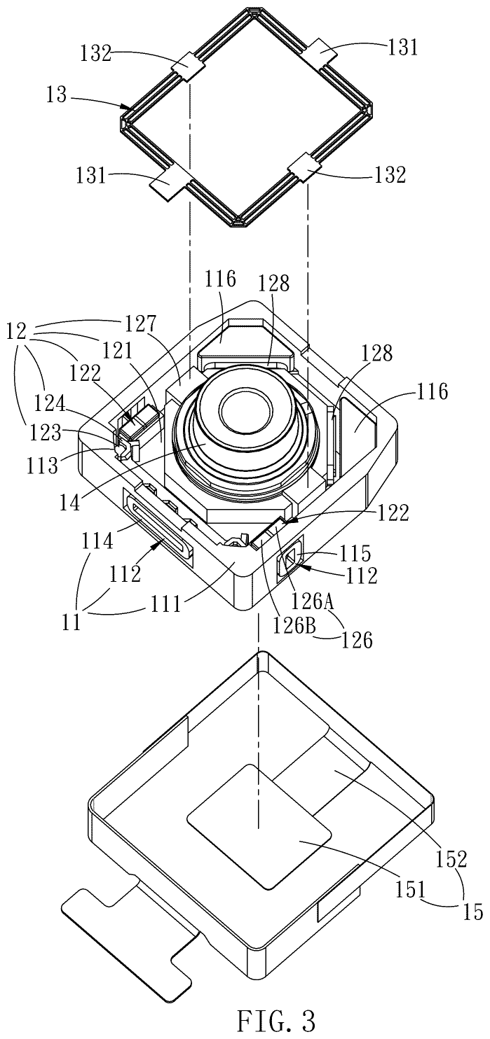

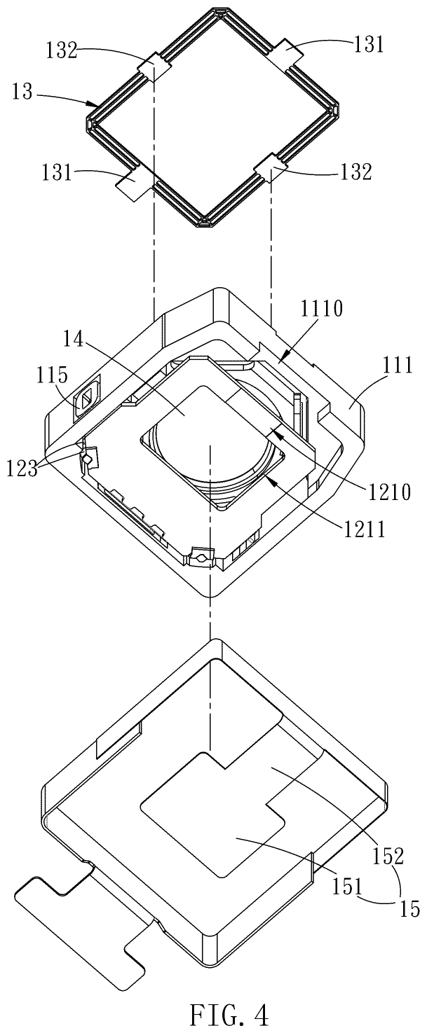

Please refer to FIG. 1 to FIG. 4, FIG. 1 is a perspective view of the camera structure in an embodiment of the present disclosure, FIG. 2 is an exploded view, FIG. 3 is an exploded view of the internal structure and FIG. 4 is another exploded view of the internal structure. As shown in the figure, a camera structure 1 which is provided in the present disclosure includes a frame unit 11 and a moving unit 12. The frame unit 11 includes a framework 111 and a first driver 112. The first driver 112 is installed on the framework 111, the inner surface of the framework 111 includes a linear chute 113, and the groove bottom of the linear chute 113 is a curved groove bottom 1131. In some embodiments, the linear chute 113 is located at the corner of the inner surface of the framework 111. The moving unit 12 includes a moving base 121, a second driver 122 and a plurality of balls 123, the moving base 121 is installed in the framework 111, the second driver 122 is installed on the moving base 121, the second driver 122 is corresponded to the first driver 112, the outer surface of the moving base 121 includes a linear groove 124, the linear groove 124 is corresponded to the linear chute 113. In some embodiments, the linear groove 124 is located at the corner of the outer surface of the moving base 121. The notch of the linear groove 124 is smaller than the notch of the linear chute 113, and the surface of the plurality of balls 123 abuts the linear groove 124 and the curved groove bottom 1131 of the linear chute 113. The first driver 112 drives the second driver 122 to bring the moving base 121 to move, the moving base 121 abuts the plurality of balls 123 to slide along the curved groove bottom 1131 of the linear chute 113, and the rotation arc of the moving base 121 is the same as the arc of the curved groove bottom 1131. The moving base 121 of the present disclosure abuts the plurality of balls 123 to slides along the curved groove bottom 1131 on multiple balls 123; in addition to rotating along the horizontal direction of the curved groove bottom 1131, the sliding directions of the plurality of balls 123 of the moving base 121 can also slide along the vertical sliding along the curved groove bottom 1131. In some embodiments, the first driver 112 is a coil set, and the second driver 122 is a magnetic set corresponded to the coil set; alternatively, the first driver 112 is a magnetic set, and the second driver 122 is a coil set corresponded to the magnetic set, but it is not limited to these configurations.

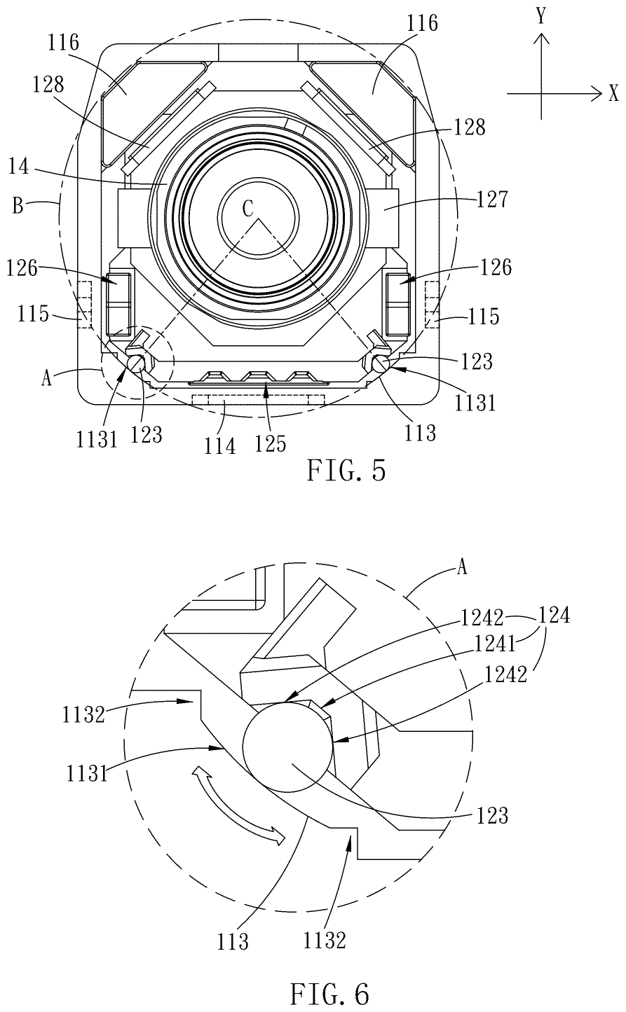

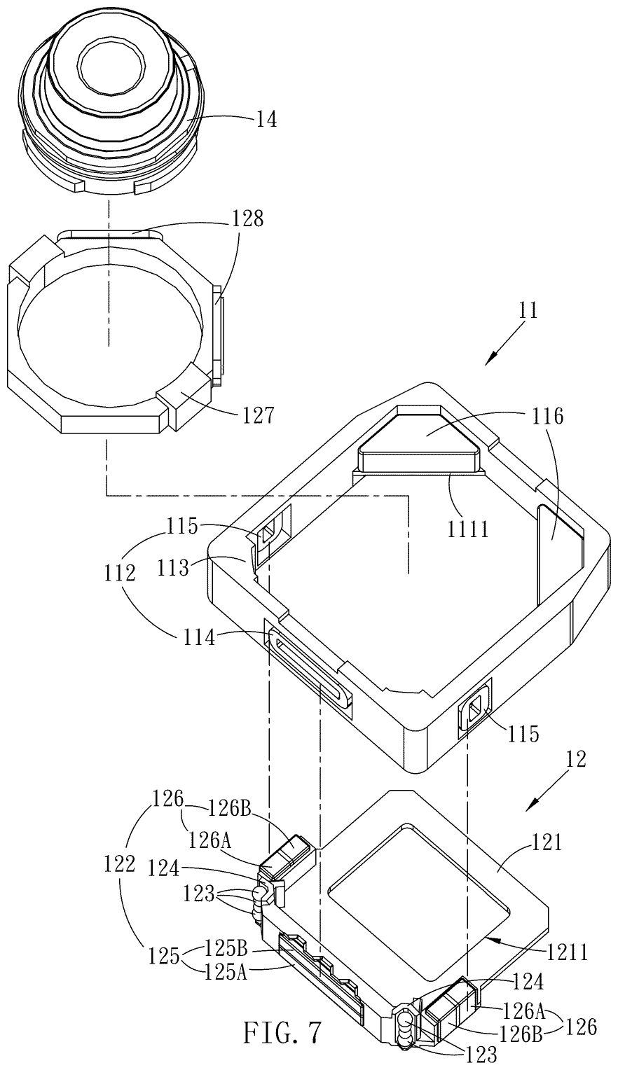

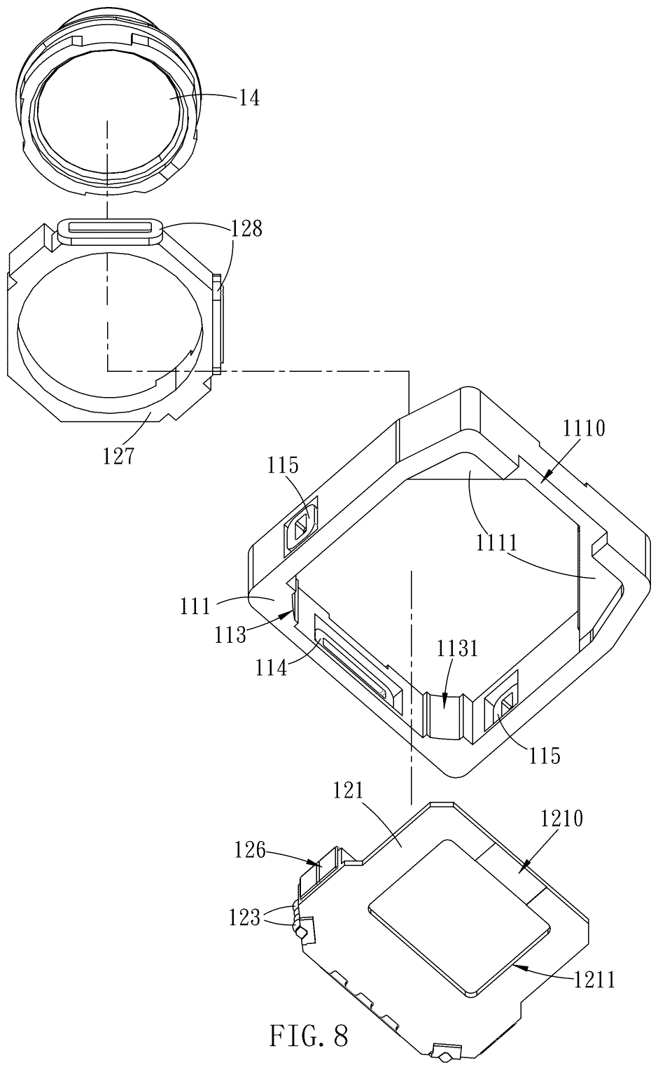

Please refer to FIG. 5 to FIG. 8, FIG. 5 is a top view of the internal structure of the camera structure in an embodiment of the present disclosure, FIG. 6 is an enlarged view of area A in FIG. 5, FIG. 7 is another exploded view and FIG. 8 is yet another exploded view. As shown in the figure, in the present embodiment, the moving base 121 includes two linear grooves 124 on its outer side, the two linear grooves 124 are located at the corners on the ends of the same side; similarly, the framework 111 includes two linear chutes 113, the two linear chutes 113 are located at the corners on the ends of the same inner surface, the two linear grooves 124 are corresponded to the two linear chutes 113 and are located in the linear chutes 113, allowing the moving base 121 to rotate relative to the framework 111. Please refer to FIG. 5, the distance from the rotation center of the moving base 121 to the curved groove bottom 1131 of the two linear chutes 113 are the same, in other words, the rotation center C of the moving base 121 is the center of a circle, and the distance from the rotation center to the curved groove bottom 1131 is the radius of rotation (as shown by the distance from C to B in the circle in FIG. 5). When the abovementioned moving base 121 rotates relative to the framework 111, the linear chutes 113 of the moving base 121 can maintain the plurality of balls 123 pressed against the curved groove bottom 1131 of the linear chutes 113. This ensures that the moving base 121 remains centered at the rotation center.

Furthermore, please refer to FIG. 6, in the present embodiment, the linear groove 124 of the moving base 121 is a V-shaped groove, and the plurality of balls 123 are placed in the linear groove 124, the surface of the plurality of balls 123 respectively abuts against the two groove walls of the linear groove 124 and the curved groove bottom 1131 of the linear chute 113; wherein the linear groove 124 includes a groove bottom 1241 and two groove walls 1242, the groove bottom 1241 is located between the two groove walls 1242, the two groove walls 1242 extend obliquely from the groove bottom 1241 towards the framework 111 and away from each other; the surface of the plurality of balls 123 respectively abuts against the two groove walls 1242 of the linear groove 124, and there is a gap between the plurality of balls 123 and the groove bottom 1241. Additionally, the linear chute 113 includes a curved groove bottom 1131 and two ball limiting walls 1132, the two ball limiting walls 1132 are located on two sides of the curved groove bottom 1131, and the two ball limiting walls 1132 extend obliquely from two sides of the curved groove bottom 1131 towards the moving base 121 and away from each other.

In some embodiments, each ball 123 has only two-point contact with the linear groove 124 and has single-point contact with the curved groove bottom 1131, which means that each ball 123 makes three-point contact with the two groove walls of the linear groove 124 and the curved groove bottom 1131. This design can minimize the contact area between the plurality of balls 123 and the linear groove 124, thereby reducing the friction of the plurality of balls 123 relative to the linear groove 124 when the plurality of balls 123 roll relative to the linear groove 124, that ensures smooth rolling of the plurality of balls 123 within the linear groove 124, as well as smooth rolling of the plurality of balls 123 along the curved groove bottom 1131. This embodiment does not limit the shape of the linear groove 124, as the purpose of the linear groove 124 is to restrict the position of the plurality of balls 123 and maintain the consistency in movement for the plurality of balls 123.

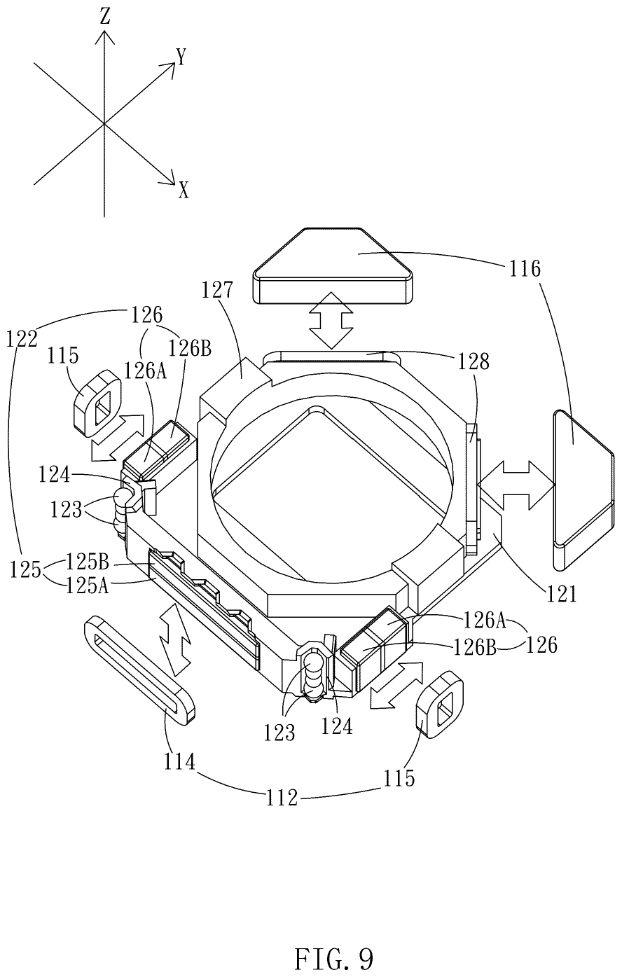

Please refer to FIG. 9, which is a schematic view of the driving direction of the camera structure of the present disclosure. As shown in the figure, in the present embodiment, the first driver 112 further includes a lifting coil 114, the lifting coil 114 is located on one side of the framework 111, the second driver 122 further includes a lifting magnetic set 125, the lifting magnetic set 125 is located on the moving base 121, the lifting magnetic set 125 is corresponded to the inside of the lifting coil 114, and the lifting coil 114 drives the lifting magnetic set 125 to bring the moving base 121 to move up and down. The lifting magnetic set 125 includes a first magnetic pole 125A and a second magnetic pole 125B, and the second magnetic pole 125B is located on the first magnetic pole 125A.

Furthermore, the first driver 112 further includes two rotating coils 115, the two rotating coils 115 are located on two opposite sides of the framework 111, the second driver 122 further includes two rotating magnetic sets 126, the two rotating magnetic sets 126 are located on two opposite sides of the moving base 121, the two rotating magnetic sets 126 are corresponded to the two rotating coils 115, and the two rotating coils 115 drive the two rotating magnetic sets 126 to move the moving base 121 to rotate. Each rotating magnetic set 126 includes a first magnetic pole 126A and a second magnetic pole 126B, the first magnetic pole 126A and the second magnetic pole 126B are arranged side by side, and the arrangement of the first magnetic pole 126A and the second magnetic pole 126B of each rotating magnetic set 126 can be adjusted according to the user's needs.

In the present embodiment, the lifting coil 114 is located on one side of the framework 111, the two rotating coils 115 are respectively located on the adjacent two sides of the lifting coil 114, and the two rotating coils 115 are also close to the side which has the lifting coil 114. In other words, the lifting magnetic set 125 which is corresponded to the lifting coil 114 is located on the moving base 121, and the second magnetic pole 125B of the lifting magnetic set 125 is stacked on the first magnetic pole 125A. The two rotating magnetic sets 126 which are corresponded to the two rotating coils 115 are located on the moving base 121, the first magnetic pole 126A of one of the rotating magnetic sets 126 is located adjacent to the side with the lifting magnetic set 125, and the second magnetic pole 126B is arranged parallel to the first magnetic pole 126A on the side away from the lifting magnetic set 125. The second magnetic pole 126B of the other one of the rotating magnetic sets 126 is located adjacent to the side with the lifting magnetic set 125, and the first magnetic pole 126A is arranged parallel to the second magnetic pole 126B on the side away from the lifting magnetic set 125

Please also refer to FIG. 3 and FIG. 9, in the present embodiment, the frame unit 11 further includes two translational magnetic units 116, the two translational magnetic units 116 are located on the inside of the framework 111 and away from the corners of the linear chute 113; the moving unit 12 further includes a bearing base 127 and two translation coils 128, the bearing base 127 is located on the moving base 121, the two translation coils 128 are located at two corners of the bearing base 127, the two translation coils 128 are correspond to the two translational magnetic units 116, the two translation coils 128 and the two translational magnetic units 116 interact with each other, and the two translation coils 128 bring the bearing base 127 to move horizontally.

Continue as above, the corner on the inside of the framework 111 away from the linear chute 113 includes a bearing platform 1111, and the two translational magnetic units 116 are placed on the bearing platform 1111. The bearing base 127 is located on the inside of the bearing platform 1111 of the framework 111. Part of the moving base 121 protrudes below the bearing platform 1111, the bearing platform 1111 is located on the Z-axis moving path of the moving base 121, thus, the bearing platform 1111 can also be considered as a Z-axis movement restriction for the moving base 121; in other words, the height to which the moving base 121 can move upwards is limited by the height of the bearing platform 1111.

Please also refer to FIG. 3, in the present embodiment, the camera structure 1 further includes an elastic part 13, the elastic part 13 is surrounded between the framework 111 and the bearing base 127, the elastic part 13 is a ring-shaped structure, the elastic part 13 includes two first fixing parts 131 and two second fixing parts 132, the two first fixing parts 131 are located on two opposite sides of the elastic part 13, and the two second fixing parts 132 are located on the other two opposite sides of the elastic part 13, the two first fixing parts 131 are connected to the framework 111, and the two second fixing parts 132 are connected to the bearing base 127. Thus, the elastic part 13 can be considered as a structure to restrict the displacement of the moving unit 12, meanwhile the elastic part 13 can further be considered as a circuit structure, to be the electrical structure to transport electrical power or control signals.

Please also refer to FIG. 7 and FIG. 8, the camera structure 1 further includes a lens unit 14, the lens unit 14 is located on the bearing base 127, in other words, the bearing base 127 can be a platform for mounting and fixing the lens unit 14. The bearing base 127 can bring the lens unit 14 to move to meet the user's needs for adjusting the shooting settings. Additionally, the camera structure 1 further includes an outer case 16, and the outer case 16 includes a lower case 161 and an upper case 162; the frame unit 11, the moving unit 12, the elastic part 13, and the lens unit 14 are located in the lower case 161; the upper case 162 includes a lens hole 1620, the upper case 162 covers the lower case 161, and the lens of the lens unit 14 passes through the lens hole 1620.

Please also refer to FIG. 3 and FIG. 4, the camera structure 1 further includes an electrical unit 15, the electrical unit 15 is located below the frame unit 11 and the moving unit 12, electrical unit 15 is located in the framework 111, the electrical unit 15 is electrically connected to the first driver 112, the electrical unit 15 can also be electrically connected to the elastic part 13, and the electrical unit 15 can be an auxiliary component for power or signal transmission via the elastic part 13. The electrical unit 15 further includes a sensor 151 and a flexible circuit board 152, the sensor 151 is corresponded to the moving base 121, the moving base 121 further includes an opening 1211, and the opening 1211 is located between the sensor 151 and the lens unit 14. Thus, the sensor 151 can directly and correspondingly receive photographic information from the lens unit 14. One end of the flexible circuit board 152 is connected to the sensor 151, and the other end extends outside of the framework 111. After the other end of the flexible circuit board 152 extends vertically upwards, the other end of the flexible circuit board 152 is divided into two sides and extends along the sides of the framework 111.

Furthermore, the side of the moving base 121 facing the electrical unit 15 includes a first notch 1210, and the side of the framework 111 facing the electrical unit 15 includes a second notch 1110; the first notch 1210 of the moving base 121 is corresponded to the second notch 1110 of the framework 111, which means that the first notch 1210 and the second notch 1110 are located on the same path, after the other end of the flexible circuit board 152 sequentially passes through the first notch 1210 of the moving base 121 and the second notch 1110 of the framework 111, the other end of the flexible circuit board 152 extends to the outside of the framework 111. Additionally, please refer to FIG. 1 and FIG. 2, part of the flexible circuit board 152 extends out of the outer case 16, facilitating electrical connections of the flexible circuit board 152 with external circuits.

Please refer to FIG. 5 and FIG. 9, in the present embodiment, the user controls the displacement of the moving unit 12 via the electrical unit 15, causing the moving unit 12 to bring the lens element 14 to adjust to meet the desired shooting angle and position for the user. When the lifting coil 114 conducts electricity, the lifting coil 114 generates a corresponding magnetic field, the magnetic field of the lifting coil 114 interacts with the first magnetic pole 125A and the second magnetic pole 126B of the lifting magnetic set 125, producing an upward or downward magnetic force, thus causing the displacement in the Z-axis direction. The lifting magnetic set 125 brings the moving base 121 to move up or down, meanwhile the plurality of balls 123 of the moving base 121 maintain pressure and roll within the curved groove bottom 1131 of the linear chute 113, allowing the balls 123 to slide up and down.

Furthermore, when the two rotating coils 115 conduct electricity, the two rotating coils 115 generate corresponding magnetic fields, the magnetic fields of the two rotating coils 115 interact with the first magnetic pole 126A and the second magnetic pole 126B of the two rotating magnetic sets 126, producing a horizontal magnetic force; the combination of the two rotating magnetic sets 126 and the two rotating coils 115 can be described in terms of a first group and a second group, the first group of rotating coils 115 produces a positive magnetic force in the Y-axis direction on the rotating magnetic set 126, and the magnetic poles of the first group and the second group of rotating magnetic sets 126 are opposite; in other words, the second group of rotating coils 115 produces a negative magnetic force in the Y-axis direction on the rotating magnetic set 126. The magnetic forces from the first group and the second group act simultaneously on the moving base 121, causing displacement in the XY plane direction. The first group and the second group of rotating magnetic sets 126 bring the moving base 121 to rotate clockwise, meanwhile the plurality of balls 123 of the moving base 121 maintain pressure and roll within the curved groove bottom 1131 of the linear chute 113, allowing the balls 123 to rotate and slide. Additionally, the two rotating coils 115 can also generate opposite magnetic fields, causing the first group and the second group of rotating magnetic sets 126 to bring the moving base 121 to rotate counterclockwise, thus there is no need for furthermore description.

Additionally, when the two translation coils 128 conduct electricity, the two translation coils 128 generate corresponding magnetic fields, the magnetic fields of the two translation coils 128 create horizontal magnetic forces relative to the two translational magnetic units 116; the combination of the two translational magnetic units 116 and the two translation coils 128 can be described in terms of a first group and a second group. The translation coils 128 of the first group and the second group generate the attraction or repulsion forces in the X-axis and Y-axis directions on the translational magnetic units 116. Through the magnetic forces between the first group and the second group of the translation coils 128 and the translational magnetic units 116, the abovementioned bearing base 127 achieves that the first group and the second group of translation coils 128 bring the bearing base 127 to move in the XY plane.

In summary, a camera structure is provided in the present disclosure, its moving base is installed in the framework, the corners of the outer surface of the moving base includes the linear grooves, and the corners of the inner surface of the framework includes the linear chutes. The groove bottom of the linear chutes is a curved groove bottom, the linear grooves are corresponded to the linear chutes, and the surface of plurality of balls abuts the linear grooves and the curved groove bottoms of the linear chutes. The moving base slides and rotates against the plurality of balls within the curved groove bottom of the linear chute, and the rotation arc of the moving base is the same as the arc of the curved groove bottom.

It should be noted that the terms “comprising,” “including,” or any other variations thereof are intended to cover non-exclusive inclusion, so that a process, method, product, or device that includes a list of elements not only includes those elements but also includes other elements not explicitly listed, or elements inherent to such a process, method, product, or device. Without further limitation, an element defined by the phrase “comprising a . . . ” does not exclude the presence of additional identical elements in the process, method, product, or device that comprises the element.

The above descriptions illustrate and describe several preferred embodiments of the present disclosure. However, as mentioned previously, it should be understood that the present disclosure is not limited to the forms disclosed herein, and should not be considered as excluding other embodiments. The present disclosure can be applied to various other combinations, modifications, and environments, and can be modified by those skilled in the relevant art without departing from the spirit and scope of the invention, which should be within the scope of the claims appended to this invention.

What is claimed is:

1. A camera structure, comprising:
a frame unit, comprising a framework and a first driver, wherein the first driver is located on the framework, an inner surface of the framework comprises a linear chute, a groove bottom of the linear chute is a curved groove bottom; and
a moving unit, comprising a moving base, a second driver and a plurality of balls, wherein the moving base is installed in the framework, the second driver is located on the moving base, the second driver is corresponded to the first driver, an outer surface of the moving base comprises a linear groove, the linear groove is corresponded to the linear chute, a notch of the linear groove is smaller than a notch of the linear chute, the plurality of balls abut an inside of the linear groove and the curved groove bottom of the linear chute;
wherein the first driver is configured to drive the second driver to bring the moving base to move, the moving base abuts the plurality of balls to slide on the curved groove bottom of the linear chute, a rotation arc of the moving base is the same as an arc of the curved groove bottom.

2. The camera structure as claimed in claim 1, wherein the first driver further comprises a lifting coil, the lifting coil is located on one side of the framework, the second driver further comprises a lifting magnetic set, the lifting magnetic set is located on the moving base, the lifting magnetic set is corresponded to an inside of the lifting coil, and the lifting coil drives the lifting magnetic set to bring the moving base to move up and down.

3. The camera structure as claimed in claim 1, wherein the first driver further comprises two rotating coils, the two rotating coils are respectively located on two opposite sides of the framework, the second driver further comprises two rotating magnetic set, the two rotating magnetic sets are respectively located on two opposite sides of the moving base, the two rotating magnetic sets are corresponded to the two rotating coils, and the two rotating coils drives the two rotating magnetic sets to bring the moving base to rotate.

4. The camera structure as claimed in claim 3, wherein each of the rotating magnetic sets comprises a first magnetic pole and a second magnetic pole, the first magnetic pole and the second magnetic pole are arranged side by side, and two magnetic poles corresponded to the two rotating magnetic sets are different from each other.

5. The camera structure as claimed in claim 1, wherein an amount of the linear chute is two, the two linear chutes are respectively located at two corners of the inner surface of the framework, the moving base rotates relative to the framework, a distance from a rotation center of the moving base to the curved groove bottom of the two linear chutes are the same.

6. The camera structure as claimed in claim 1, wherein the linear groove of the moving base is a V-shaped groove, the plurality of balls are located in the linear groove, the surface of the plurality of balls respectively abuts two groove walls on two sides of the linear groove.

7. The camera structure as claimed in claim 1, wherein each of the plurality of balls is in two-point contact with the linear groove, and each of the plurality of balls is in single-point contact with the curved groove bottom.

8. The camera structure as claimed in claim 1, wherein the linear groove comprises a groove bottom and two groove walls, the groove bottom is located between the two groove walls, the two groove walls extends obliquely from two sides of the groove bottom towards the framework and away from each other, the surface of the plurality of balls respectively abuts the two groove walls of the linear groove, and a gap is between the plurality of balls and the groove bottom.

9. The camera structure as claimed in claim 1, wherein the linear chute further comprises two ball limiting walls, the two ball limiting walls are located on two sides of the curved groove bottom, the two ball limiting walls extend obliquely from two sides of the curved groove bottom towards the moving base and away from each other.

10. The camera structure as claimed in claim 1, wherein the frame unit further comprises two translational magnetic units, the two translational magnetic units are located on an inside of the framework and away from an corner of the linear chute, the moving unit further comprises a bearing base and two translation coils, the bearing base is located on the moving base, the two translation coils are located at two corners of the bearing base, the two translation coils are corresponded to the two translational magnetic units, the two translation coils and the two translational magnetic units interact with each other, and the two translation coils bring the bearing base to move horizontally.

11. The camera structure as claimed in claim 10, further comprising an elastic part, the elastic part is surrounded between the framework and the bearing base, the elastic part comprises two first fixing parts and the two second fixing parts, the two first fixing parts are located on two opposite sides of the elastic part, the two second fixing parts are located on the other two opposite sides of the elastic part, the two first fixing parts are located on the framework, and the two second fixing part are connected to the bearing base.

12. The camera structure as claimed in claim 10, wherein an inner corner of the framework away from the linear chute comprises a bearing platform, the two translational magnetic units are placed on the bearing platform, a part of the moving base protrudes below the bearing platform, and the bearing platform is located on a moving path of the moving base.

13. The camera structure as claimed in claim 1, further comprising an electrical unit, wherein the electrical unit is located under the frame unit and the moving unit, the electrical unit is electrically connected to the first driver, the electrical unit further comprises a sensor and a flexible circuit board, the sensor is corresponded to the moving base, one end of the flexible circuit board is connected to the sensor, the other end of the flexible circuit board extends to an outside of the framework, after the other end of the flexible circuit board extends vertically and upwardly, the other end of the flexible circuit board is divided into two sides and extends along a side of the framework.

14. The camera structure as claimed in claim 13, wherein the moving base comprises a first notch on a surface opposite to the electrical unit, the framework comprises a second notch on a surface opposite to the electrical unit, the first notch of the moving base are corresponded to the second notch of the framework, the other end of the flexible circuit board passes through the first notch of the moving base and the second notch of the framework in sequence.
